(19) United States
(12) Patent Application Publication
(10) Pub. No.: US 2021/0381665 A1
(43) Pub. Date: Dec. 9, 2021

(54) Lighting Device for a False Ceiling, False Ceiling Comprising Such Lighting Device and Method for Fitting Such Lighting Device

(71) Applicant: CERTAINTEED CORPORATION, Malvern, PA (US)

(72) Inventors: Dennis Michaud, Groton, MA (US); Simon Bobbo, Milan (IT); Matteo Caldon, Milan (IT); Roberta Frare, Milan (IT); Lorenzo Baldo, Milan (IT); Eleonora Pappalardo, Milan (IT); Alessandro Scordino, Milan (IT); Francesca Peruzzo, Milan (IT); Werner De Groodt, Milan (IT); Kim Dupont-Madinier, Somerville, MA (US); Timothy Briggs, Clinton, MA (US)

(21) Appl. No.: 16/645,771

(22) PCT Filed: Nov. 7, 2018
(86) PCT No.: PCT/US2018/059673

§ 371 Date: Mar. 9, 2020

(30) Foreign Application Priority Data
Sep. 7, 2017 (IT) 102017000100445

(51) Int. Cl. F21S 8/04; F21V 8/00; F21V 7/05; E04B 9/00; E04B 9/06

(52) U.S. Cl. CPC F21S 8/04; G02B 6/0011; E04B 9/068; E04B 9/006; F21V 7/05

(57) ABSTRACT

Lighting device (22) for a false ceiling (10) comprising a plurality of T-profiles (14) having respective longitudinal axes (A) and arranged in a square mesh grid (12), in which each T-profile (14) has a lower wall with a width (W) and in which the grid (12) has a center distance (D) between the longitudinal axes (A) of T-profiles (14) parallel and adjacent to one another, in which the lighting device (22) has an elongated parallelepiped shape with a width (W′) comparable to the width (W) of said T-profiles (14), a height (h) of less than 15 mm and a length (D′) comparable to said center distance (D) between the longitudinal axes (A) of T-profiles (14) parallel and adjacent to one another, and in which said lighting device (22) is capable of being fitted directly in contact with the lower wall of a respective T-profile (14).

### CROSS-REFERENCE TO RELATED APPLICATIONS

This application claims the benefit of priority of Italian Patent Application no. 102017000100445, filed Sep. 7, 2017, which is hereby incorporated herein by reference in its entirety.

### BACKGROUND OF THE DISCLOSURE

### Technical Field

This invention refers to lighting devices.

One or more embodiments can refer to lighting devices for false ceilings.

One or more embodiments can refer to lighting devices using solid-state light radiation sources, such as LED sources.

One or more embodiments can relate to a false ceiling and a method for fitting lighting devices in a false ceiling.

### Technological Background

A false ceiling is a construction work with a lightweight structure placed beneath the ceiling of a building, which causes a reduction in the useful height of the room concerned. A false ceiling can be made in order to meet aesthetic requirements or to apply a covering of heat-insulating, soundproofing or fire-resistant material. A false ceiling can also be used to house one or more systems in the space created between the false ceiling and the ceiling.

The system most typically housed in a false ceiling is the lighting system. The lighting devices can be anchored to the support structure of the false ceiling and the empty space existing between the ceiling and the false ceiling can allow wires to be run to supply electrical power to the lighting devices.

A false ceiling can comprise a support structure formed by a plurality of inverted T-profiles arranged in a square mesh grid. The T-profiles can have respective lower horizontal wings on which the edges of square-shaped false-ceiling panels can rest.

Various solutions for fitting lighting devices in a false ceiling exist. One very widespread solution involves removing false-ceiling panels and fitting in place of the false-ceiling panels square lighting devices that occupy the space occupied by the removed false-ceiling panel.

An alternative solution can envisage the use of linear lighting devices. In this case false-ceiling panels are not removed but sections of T-profiles of the false ceiling structure are removed, which are then replaced by linear lighting devices that can have an inverted T-shaped transverse section having horizontal surfaces on which the edges of the false-ceiling panels adjacent to the lighting devices can rest. This solution can give the false ceiling a more uniform appearance and can provide a certain degree of flexibility in the arrangement of the lighting devices. However, one critical aspect of this solution is that it may be necessary to remove sections of the metal structure supporting the false ceiling and replace the sections of T-profiles with corresponding lighting devices.

In a false ceiling with false-ceiling panels measuring 600×600 mm, the grid support structure may comprise main longitudinal profiles typically of a length of 3,700 mm, transverse profiles typically of a length of 1,200 mm and intermediate profiles typically of a length of 600 mm, arranged so as to form a square mesh grid with 600×600 mm sides.

A lighting system that involves replacing portions of the T-profiles of the false-ceiling grid with linear lighting devices does not usually allow the installation of lighting devices in any position in the false-ceiling grid. In fact, the main longitudinal profiles are typically too long to be replaced. The lighting devices can take the place of transverse or intermediate T-profiles. This limits the possible configurations of the lighting system. For example, with this system it is not usually possible to fit four lighting devices along the perimeter of a false-ceiling panel since this arrangement would require the replacement of part of a main longitudinal profile, which is a very complex operation.

Another limitation is that the lighting devices should preferably be installed during the construction of the false-ceiling supporting grid since the replacement of T-profiles in a false ceiling that already exists is a very complex operation.

### SUMMARY OF THE DISCLOSURE

One or more embodiments have the aim of helping to overcome the above-described drawbacks.

More specifically, one or more embodiments have the aim of providing a lighting device that can be fitted on false-ceiling structures without removing false-ceiling panels or T-profiles of the false-ceiling metal support structure.

According to one or more embodiments, these aims can be achieved by a lighting device having the characteristics described in the accompanying claims.

One or more embodiments can also relate to a false ceiling provided with linear lighting devices and a method for fitting lighting devices in a false ceiling.

### BRIEF DESCRIPTION OF THE FIGURES

One or more embodiments will now be described, purely by way of non-limiting examples, with reference to the accompanying Figures, in which:

FIG. 1 is a perspective view showing a part of a false ceiling,

FIG. 2 is a plan view showing a lighting device fitted in a false-ceiling structure,

FIG. 3 is a schematic section along Line III-III of FIG. 2,

FIG. 4 is a plan view showing various arrangements of lighting devices in a false ceiling,

FIGS. 5 and 6 are schematic sections showing possible systems for fixing a lighting device to a T-profile of a false ceiling,

FIGS. 7 and 8 are schematic sections showing systems for the electrical supply of a lighting device fitted in a false ceiling, and

FIGS. 9, 10 and 11 are schematic cross-sections showing embodiments of lighting devices for false ceilings.

It will be appreciated that, for clarity and simplicity of illustration the various Figures may not be reproduced to the same scale.

### DETAILED DESCRIPTION

The following description illustrates various specific details aimed at an in-depth understanding of examples of one or more embodiments. The embodiments may be made without one or more of the specific details, or using other methods, components, materials, etc. In other cases, known structures, materials or operations are not shown or described in detail so as to avoid making various aspects of the embodiments unclear. The reference to “an embodiment” in the context of this description indicates that a particular configuration, structure or characteristic described in relation to the embodiments is included in at least one embodiment. Therefore, phrases such as “in an embodiment” that may appear at various points in this description do not necessarily relate to the same embodiment. Furthermore, particular conformations, structures or characteristics can be suitably combined in one or more embodiments and/or associated with the embodiments in a different way to that illustrated here, so for example a characteristic exemplified here in relation to one Figure may be applied to one or more embodiments exemplified in a different Figure.

The references illustrated here are only for convenience and therefore do not delimit the scope of protection or the scope of the embodiments.

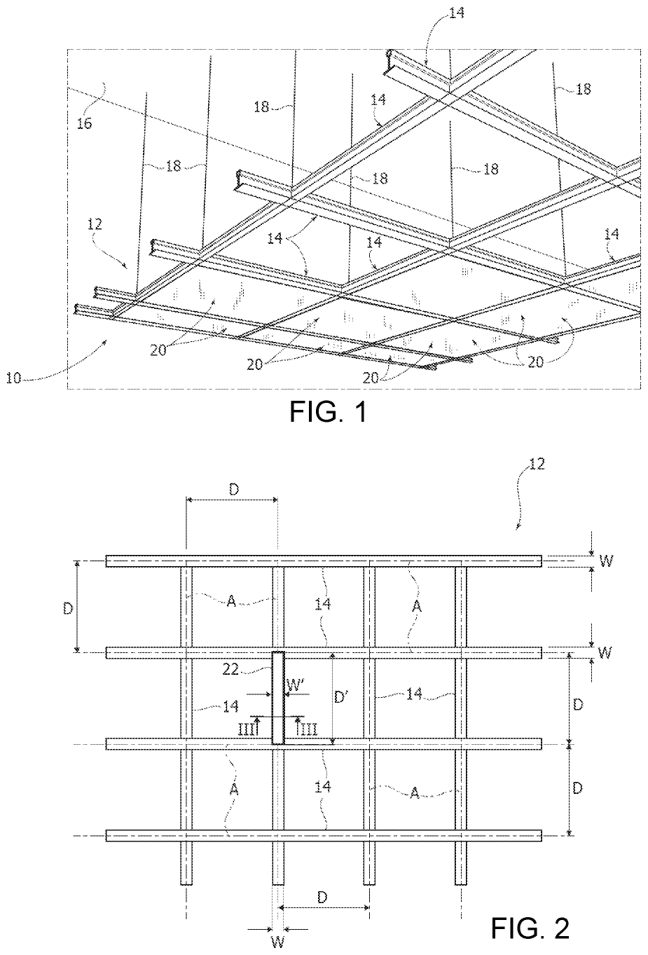

In FIG. 1, reference 10 indicates a false ceiling of a building. The false ceiling 10 can comprise a grid shaped support structure 12 that can be formed by a plurality of T-profiles 14 that can be connected to a ceiling 16 by means of wires 18. The T-profiles 14 can be arranged so as to form a square mesh grid. The T-profiles 14 can have an inverted T-shaped cross-section, having respective lower horizontal respective wings on which the edges of square false-ceiling panels 20 can rest.

Within the context of the present description, geometrical references such as, for example, horizontal, vertical, upper, lower, etc. refer to the fitted condition of a false ceiling and are not intended to limit the scope of application of the embodiments.

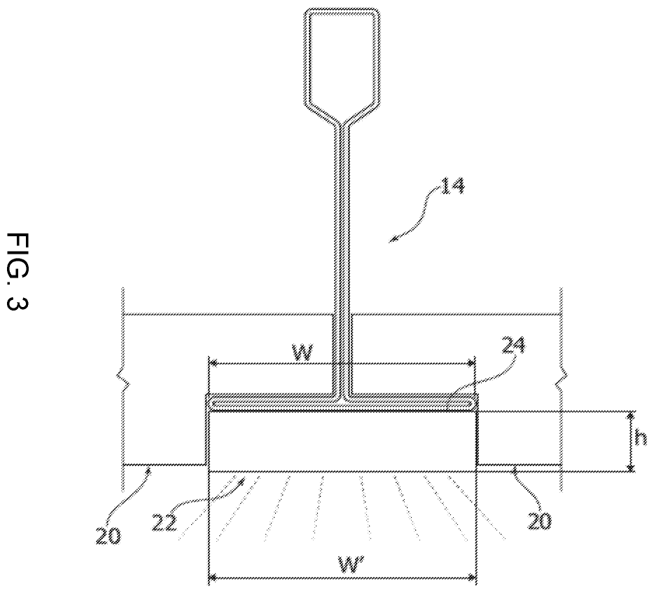

With reference to FIG. 2, the profiles 14 can have respective longitudinal axes A. The longitudinal axis A of a T-profile 14 can be defined as an axis parallel to the direction of extension of the T-profile 14 and passing though a central plane of symmetry of the cross-section of the T-profile 14.

The T-profiles can have a width W, that can be defined as the dimension of a lower surface of a T-profile 14 along a direction orthogonal to the longitudinal axis A of the T-profile 14. The width W can be a constant value, bearing in mind the normal construction tolerances of T-profiles 14.

In FIG. 2, D shows the center distance between the longitudinal axes A of two T-profiles 14 parallel and adjacent to each other, bearing in mind the ordinary fitting tolerances for T-profiles in a false ceiling.

With reference to FIGS. 2 and 3, 22 shows a lighting device designed to be fitted on the support structure 12 of a false ceiling 10. In one or more embodiments, the lighting device 22 can have an elongated parallelepiped shape, with a rectangular cross-section.

In one or more embodiments, the lighting device can have a width W′ comparable to the width W of the T-profiles 14.

In one or more embodiments, taking into account the ordinary production tolerances of T-profiles 14 and lighting devices 22, the lighting device can have a width W′ equal to the width W of the T-profiles 14.

In one or more embodiments, the lighting device 22 can have a length D′ (FIG. 2) comparable to the center distance D between two T-profiles 14 that are parallel and adjacent to one another.

In one or more embodiments, taking into account the ordinary manufacturing tolerances of the lighting devices and the ordinary fitting tolerances of the T-profiles 14 in a false ceiling, the lighting device 22 can have a length D′ equal to the center distance D between two T-profiles 14 that are parallel and adjacent to one another.

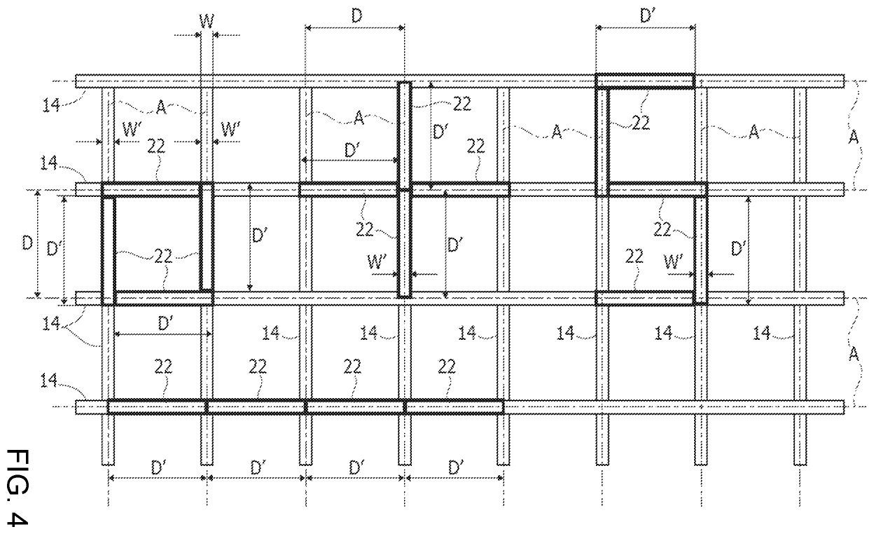

In one or more embodiments, first lighting devices 22 can be provided that can have a length D′₁=D+W and second lighting devices 22 that can have a length D′₂=D−W. By using lighting devices 22 with lengths D′₁ and D′₂ together in the same grid structure of the false ceiling, all of the arrangements shown in FIG. 4 are possible.

With reference to FIG. 3, in one or more embodiments the lighting device 22 can have a height h of less than 15 mm. In one or more embodiments the lighting device 22 can have a height h of between 5 and 7 mm. This dimension of the height h of the lighting device 22 can allow the upper surface of the lighting device to be substantially flush with the lower surface of the false-ceiling panels 20 in the case of false-ceiling panels 20 provided with recessed support surfaces, as shown in FIG. 3.

In one or more embodiments, the lighting device 22 can have a flat upper surface 24, which is designed to be arranged in contact with a lower flat surface of a T-profile 14.

With reference to FIG. 4, given that the length D′ of the lighting devices 22 can be equal to the center distance D between two T-profiles 14 parallel and adjacent to one another, the lighting device 22 can be arranged according to a plurality of different geometrical configurations. For example, the lighting devices 22 can be arranged so as to form a square along the perimeter of a false-ceiling panel, or in cross and S configurations or in a linear arrangement.

In one or more embodiments, the lighting devices 22 can be fixed directly to respective T-profiles 14, without the need to remove or replace T-profiles 14 or sections thereof.

The lighting devices can be fixed to the T-profiles 14 by means of one of the following fixing systems:
double-sided adhesive tape between the upper surface 24 of a lighting device and the lower surface of a T-profile 14;
clips or fixing elements of a commercially available type;
magnetic elements carried by the lighting device 22 and cooperating with the T-profiles 14 (normally consisting of ferromagnetic material, usually steel);
snap-fit systems between the lighting device 22 and the lower part of a T-profile 14.

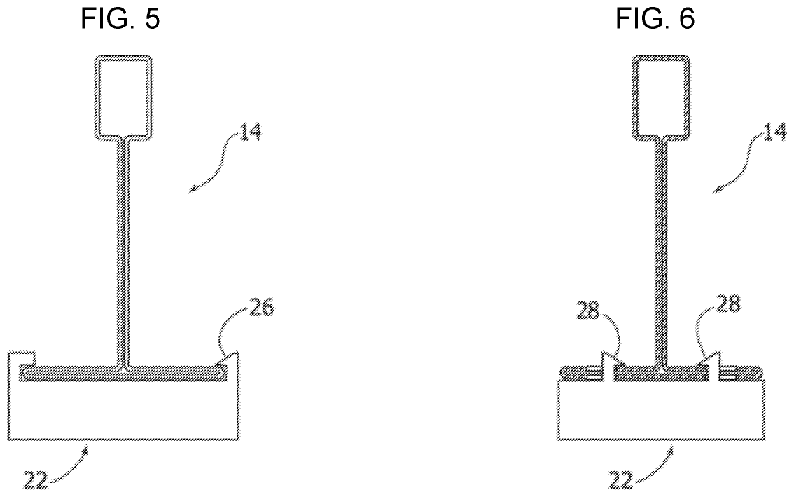

As shown in FIGS. 5 and 6, snap-fit systems can comprise resilient teeth 26 arranged so as to snap fit onto the outer edges of the T-profile 14 (FIG. 5) or resilient teeth 28 arranged so as to snap fit into respective holes formed in the wings of the T-profiles 14 (FIG. 6).

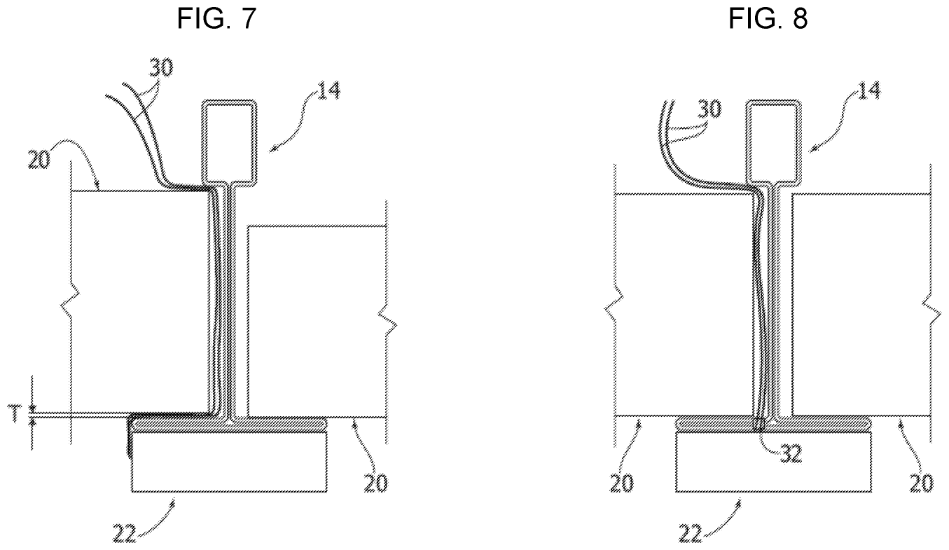

FIGS. 7 and 8 show schematic representations of two methods for the electrical connection of the lighting devices 22 to the electrical power supply, usually arranged above the false ceiling. Electrical supply wires 30 can pass alongside the T-profiles 14 (FIG. 7) or through holes 32 formed in the lower wall of the T-profiles 14 (FIG. 8). In the example shown in FIG. 7, the wires 30 can cause a slight lifting of the false-ceiling panels 20 of a thickness T equal to the thickness of the wires 30. The lifting effect T can be minimized by using thin wires 30. The advantage of the solution in FIG. 7 is that no changes to the T-profiles 14 are required so it is therefore simple and quick.

In order to pass the electrical supply wires 30 through the T-profiles 14 it may be necessary to make holes 32 in the wings of the T-profiles 14, for example by means of drilling, punching, etc. The advantage of this solution is that it creates no lifting effect of the false-ceiling panels at the points where the electrical supply wires 30 pass through.

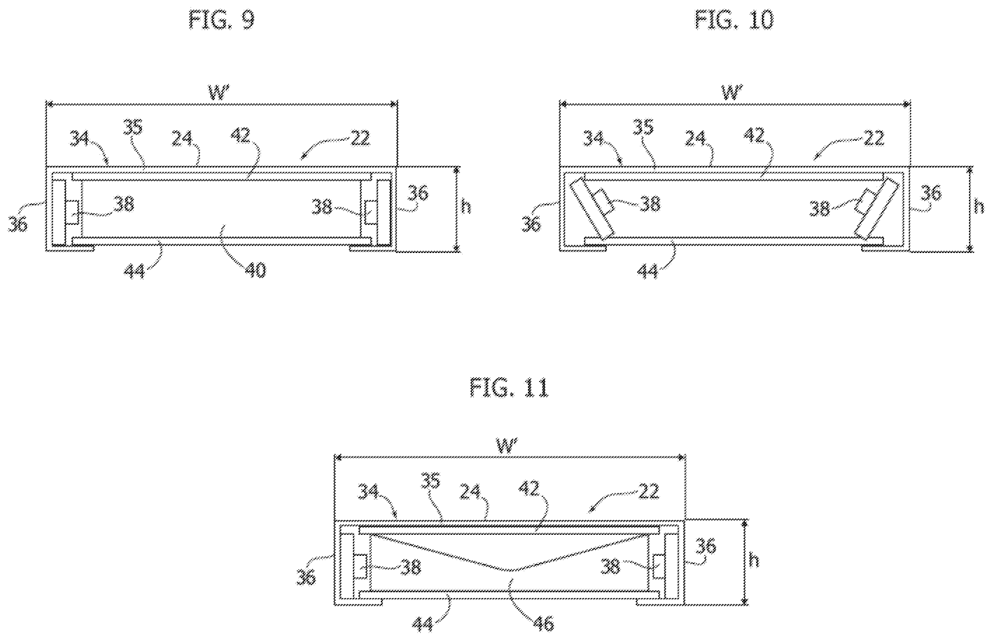

FIGS. 9, 10 and 11 show schematic cross-sections of various embodiments of linear lighting devices 22.

In one or more embodiments, the lighting device 22 may comprise a casing 34 having a flat upper surface 24 intended to be arranged in contact with the lower surface of a T-profile 14.

The casing 34 can consist of various materials and can be obtained by means of various production processes, such as for example:
extruded metal (steel or aluminum);
pressed metal (steel or aluminum);
extruded plastics material;
pressed plastics material;
folded sheet metal (steel or aluminum).

The production of the casing 34 of the lighting device 22 by means of folded sheet metal can offer various advantages, such as for example:
low production costs: the process of folding sheet metal can be completely automated so, after the investment for the folding dies, the unit price of the components is very low compared to other processes;
low cost of sheet metal;
very small thickness of sheet metal (as little as 0.2-0.3 mm).

The small thickness of the walls of the casing 34 that can be obtained using folded sheet metal can offer various advantages, including:
low cost;
light weight;
reduced size of the walls: when the lighting devices are mounted next to one another, the separation line between two lighting devices can be barely visible, which improves light continuity;
the sheet metal can be the same as that used for the T-profiles 14 of the false-ceiling structure: in this way, a perfect color match can be achieved.

Furthermore, the sheet metal folding process enables excellent freedom in the formation of holes, channels and other elements that would require a second manufacturing stage if the casing were made using an extrusion process. Furthermore, the folding process is more economical than a pressing process.

In one or more embodiments, the casing 34 can have an upper wall 35 and two sides 36 arranged, in cross-section, in a general C-shape. The sides 36 can be straight and parallel to one another. In one or more embodiments, the sides 36 can be orthogonal to the upper wall 35.

In one or more embodiments, the lighting device 22 may comprise a plurality of light radiation sources 38 mounted along the sides 36 of the casing 34. The light radiation sources 38 can be solid-state light radiation sources, such as LEDs.

To achieve optimum light homogeneity and an acceptable optical efficiency while keeping the thickness of the lighting device sufficiently small (approximately 5-7 mm), the solutions shown schematically in FIGS. 9, 10 and 11 can be adopted.

In the solution shown in FIG. 9, the light radiation sources 38 can be arranged on the opposite sides 36 of the casing 34, with a direction of emission orthogonal to the sides 36. A light guide 40, of light-diffusing plastic for example, can be arranged between the light radiation sources 38. A reflective sheet 42 can be applied to the internal surface of the upper wall 35 of the casing 40. A reflection-control film 44 can be applied at a light-emission window of the casing 34.

With reference to FIG. 10, in one or more embodiments the light guide 40 can be omitted. The light radiation sources 38 can be arranged inclined upwards. A reflective sheet 42 can reflect towards the emission window the light radiation coming directly from the light radiation sources 38. A reflection-control film 44 can be arranged at the emission window of the casing 34.

With reference to FIG. 11, in one or more embodiments the lighting device 22 can comprise light radiation sources 38 arranged along the sides 36 of the casing 34 in a direction of emission orthogonal to the sides 36. A shaped light guide 46 made, for example, of transparent plastics material can be arranged between the light radiation sources 38. A reflective sheet 42 can be applied to the inner surface of the upper wall of the casing 34 in order to recycle the light. A reflection-control film 44 can be arranged at the emission window of the casing 34.

One or more embodiments can offer one or more of the following advantages:
the lighting device can be perfectly integrated with the aesthetic appearance of the false ceiling: for example, effects of lifting of the false-ceiling panels, holes or channels visible on the false-ceiling panels, or any interruption or change in the homogeneity of the false-ceiling panels can be avoided;
the lighting device can provide a uniform light emission and can keep reflection under control;
a wide variety of light device arrangements are possible without having to remove elements of the grid structure: for example, the lighting devices can be arranged along the perimeter of a false-ceiling panel without creating dark areas or the lighting devices can be installed perpendicular to one another at the intersections of the supporting grid;
the installation of lighting devices can be simple and quick and can also be performed by non-specialized personnel (for example, not necessarily by an electrician);
lighting devices can be replaced simply and quickly;
the lighting devices can be produced using conventional technologies so the final cost of the lighting devices is comparable with that of the LED panels already commercially available;
it is possible to achieve a perfect match of colors between the T-profiles of the support structure of the false ceiling and the casings of the lighting devices; and
the lighting devices can be installed at any time, both during and after construction of the supporting grid.

One or more embodiments can therefore relate to a lighting device (e.g. 22) for a false ceiling (e.g. 10) comprising a plurality of T-profiles (e.g. 14) having respective longitudinal axes (e.g. A) and arranged in a square mesh grid (e.g. 12), in which each T-profile (e.g. 14) has a lower wall with a width (e.g. W) and in which the grid (e.g. 12) has a center distance (e.g. D) between the longitudinal axes (e.g. A) of T-profiles (e.g. 14) parallel and adjacent to one another, in which the lighting device (e.g. 22) can have an elongated parallelepiped shape with a width (e.g. W′) comparable to the width (e.g. W) of said T-profiles (e.g. 14), a height (e.g. h) of less than 15 mm and a length (e.g. D′) comparable to said center distance (e.g. D) between the longitudinal axes (e.g. A) of T-profiles (e.g. 14) parallel and adjacent to one another, and in which said lighting device (e.g. 22) is capable of being fitted directly in contact with the lower wall of a respective T-profile (e.g. 14).

In one or more embodiments, the lighting device may be capable of being fixed to the lower wall of a T-profile (e.g. 14) by means of:
double-sided adhesive tape,
clips,
magnetic elements, or snap-fit formations.

In one or more embodiments, the lighting device can comprise a casing (e.g. 34) having a C-shaped cross-section.

In one or more embodiments said casing (e.g. 34) can be formed by means of:
extrusion of metal material,
pressing of sheet metal,
extrusion of plastics material,
pressing of plastics material, or
folding of sheet metal.

In one or more embodiments, the lighting device can comprise a plurality of electrically powered light radiation sources (e.g. 38) arranged along the sides (e.g. 36) of said casing (e.g. 34).

In one or more embodiments, the lighting device may comprise a reflective sheet (e.g. 42) applied to an inner surface of an upper wall (e.g. 35) of said casing (e.g. 34).

In one or more embodiments, the lighting device can comprise a reflection-control film (e.g. 44) applied at a light emission window of said casing (e.g. 34).

In one or more embodiments, the lighting device can comprise a light guide (e.g. 40) applied between light radiation sources (e.g. 38) located on opposite sides (e.g. 36) of said casing (e.g. 34).

One or more embodiments can relate to a false ceiling (e.g. 10) comprising:
a plurality of T-profiles (e.g. 14) having respective longitudinal axes (e.g. A) and arranged according to a square mesh grid (e.g. 12), in which each T-profile (e.g. 14) has a lower wall with a width (e.g. W) and in which the grid (e.g. 12) has a center distance (e.g. D) between the longitudinal axes (e.g. A) of T-profiles (e.g. 14) that are parallel and adjacent to one another, and
a plurality of lighting devices (e.g. 22) having an elongated parallelepiped shape with a width (e.g. W′) comparable to the width (e.g. W) of said T-profiles (e.g. 14), a height (e.g. h) less than 15 mm and a length (e.g. D′) comparable to said center distance (e.g. D) between the longitudinal axes (A) of the T-profiles (e.g. 14) parallel and adjacent to one another,

wherein said lighting devices (e.g. 22) can be fitted directly in contact with the lower walls of said T-profiles (e.g. 14).

One or more embodiments can relate to a method for fitting lighting devices in a false ceiling (e.g. 10) comprising:
providing a plurality of lighting devices (e.g. 22), and
fixing said lighting devices (e.g. 22) to lower walls of T-profiles (e.g. 14) of a square mesh grid (e.g. 12) of the false ceiling (e.g. 10).

Without prejudice to the basic principles, the details of manufacture and the embodiments can vary, even significantly, compared to that illustrated here purely by way of non-limiting example, without departing from the scope of protection.

This scope of protection is defined by the accompanying claims.

1-10. (canceled)

11. A lighting device fora false ceiling, the false ceiling comprising a plurality of T-profiles having respective longitudinal axes and arranged in a grid, in which each T-profile has a lower wall with a width and in which the grid has a center distance between the longitudinal axes of T-profiles parallel and adjacent to one another, in which the lighting device has an elongated parallelepiped shape with a width comparable to the width of said T-profiles, a height of less than 15 mm and a length comparable to said center distance between the longitudinal axes of T-profiles parallel and adjacent to one another, and in which said lighting device is capable of being fitted directly in contact with the lower wall of a respective T-profile.

12. The lighting device according to claim 11, capable of being fixed to the lower wall of a T-profile by double-sided adhesive tape, clips, magnetic elements, or snap-fit formations.

13. The lighting device according to claim 11, comprising a casing having a C-shaped cross-section.

14. The lighting device according to claim 13, wherein said casing is formed by extrusion of metal material, pressing of sheet metal, extrusion of a plastic material, pressing of a plastic material, or folding of sheet metal.

15. The lighting device according to claim 13, further comprising a plurality of electrically powered light radiation sources arranged along one or more sides of said casing.

16. The lighting device according to claim 15, comprising a light guide applied between light radiation sources located on opposite sides of said casing.

17. The lighting device according to claim 13, further comprising a reflective sheet applied to an inner surface of an upper wall of said casing.

18. The lighting device according to claim 13, further comprising a reflection-control film applied at a light emission window of said casing.

19. A false ceiling comprising:
a plurality of T-profiles having respective longitudinal axes and arranged according to a grid, in which each T-profile has a lower wall with a width and in which the grid has a center distance between the longitudinal axes of T-profiles that are parallel and adjacent to one another, and
a plurality of lighting devices having an elongated parallelepiped shape with a width comparable to the width of said T-profiles, a height less than 15 mm and a length comparable to said center distance between the longitudinal axes of the T-profiles parallel and adjacent to one another,
wherein said lighting devices are fitted directly in contact with the lower walls of said T-profiles.

20. The false ceiling according to claim 19, wherein each lighting device is fixed to the lower wall of a T-profile by double-sided adhesive tape, clips, magnetic elements, or snap-fit formations.

21. The false ceiling according to claim 19, wherein each lighting device comprises a casing having a C-shaped cross-section.

22. The false ceiling according to claim 21, wherein said casing is formed by extrusion of metal material, pressing of sheet metal, extrusion of a plastic material, pressing of a plastic material, or folding of sheet metal.

23. The false ceiling according to claim 21, wherein each light device further comprises a plurality of electrically powered light radiation sources arranged along one or more sides of said casing.

24. The lighting device according to claim 23, wherein each light device further comprises a light guide applied between light radiation sources located on opposite sides of said casing.

25. The lighting device according to claim 21, wherein each light device further comprises a reflective sheet applied to an inner surface of an upper wall of said casing.

26. The lighting device according to claim 21, wherein each light device further comprises a reflection-control film applied at a light emission window of said casing.

27. A method for fitting lighting devices in a false ceiling comprising:
providing a plurality of lighting devices according to claim 1,
providing a false ceiling comprising a plurality of T-profiles having respective longitudinal axes and arranged in a grid, in which each T-profile has a lower wall with a width and in which the grid has a center distance between the longitudinal axes of T-profiles parallel and adjacent to one another, and
fixing said lighting devices to lower walls of T-profiles of the grid of the false ceiling.
